(19) United States
(12) Patent Application Publication
(10) Pub. No.: US 2007/0036219 A1
(43) Pub. Date: Feb. 15, 2007

(54) Video decoding method and apparatus for intensity compensation

(75) Inventors: Byung-sun Choi, Gunpo-si (KR); Tae-wook Nam, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/491,087

(22) Filed: Jul. 24, 2006

(30) Foreign Application Priority Data
Aug. 9, 2005 (KR) 10-2005-0072976

(51) Int. Cl. H04N 11/02

(52) U.S. Cl. 375/240.16; 375/240.25

(57) ABSTRACT

A video decoding method and a video decoding apparatus capable of reducing a memory bandwidth in an intensity compensation process are provided. The video decoding apparatus includes: a bit stream parsing unit which parses an input bit stream, extracts intensity compensation data of a picture to be decoded; a decoding unit which decodes the picture to be decoded; and a memory which stores the decoded picture, wherein the decoding unit comprises a motion compensation unit which reads a motion compensation picture, that is referred by the picture to be decoded for motion compensation, from the memory in block unit of a predetermined size, performs intensity compensation with respect to a motion compensation block of the motion compensation block using the intensity compensation data, and performs the motion compensation with respect to the intensity-compensated motion compensation block.

### CROSS-REFERENCE TO RELATED PATENT APPLICATION

This application claims the benefit of Korean Patent Application No. 10-2005-0072976, filed on Aug. 9, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to video decoding, and more particularly, to a video decoding method and an apparatus therefor capable of reducing a memory bandwidth in an intensity compensation (IC) process.

2. Description of the Related Art

VC-1 is a video codec standard of the society of motion picture and television engineers (SMPTE) and includes an intensity compensation (IC) process. In the IC process, the brightness of a reference picture is compensated before motion estimation and motion compensation processes, because, if the brightness of an image is changed in a whole picture even without a motion change therein, the picture is recognized as a separate picture in the motion estimation and motion compensation processes. Namely, when the brightness of the reference picture is changed as a whole in VC-1, the IC process is performed with respect to the reference picture, and the motion compensation process is performed with respect to an estimated picture using a picture processed with the IC as the reference picture.

Furthermore, a current picture is influenced by picture data processed with IC, so that a P or B picture which takes the current picture as a reference picture is influenced by the picture data during decoding. When the VC-1 is implemented as hardware, data processed with IC needs to be stored separately from the data to be displayed. So, all the data of the reference picture must be stored again after it is read from the memory and is subject to the IC process. Particularly, in the case of an interlace field mode, a frame is divided into two pictures and IC must be performed with respect to each picture, so that each picture is subject to a data reading process and is stored again. As a result, the cycle of the whole process increases. In addition, since the reference picture data is transmitted and received between a memory and a unit performing IC, macro-block pipelining is affected, and memory access becomes more frequent. Moreover, if IC is used for an image with significant amount of data such as a HD level and higher, the problems become more serious.

### SUMMARY OF THE INVENTION

The present invention provides a video decoding method and apparatus for reducing a memory bandwidth in an intensity compensation (IC) process with respect to a reference picture.

According to an aspect of the present invention, there is provided a video decoding apparatus comprising: a bit stream parsing unit which parses an input bit stream, and extracts intensity compensation data of a picture to be decoded; a decoding unit which decodes the picture to be decoded; and a memory which stores the decoded picture, wherein the decoding unit comprises a motion compensation unit which reads a motion compensation picture, that is referred to by the picture to be decoded for motion compensation, from the memory in block unit of a predetermined size, performs an intensity compensation with respect to a motion compensation block of the motion compensation picture using the intensity compensation data, and performs the motion compensation with respect to the intensity-compensated motion compensation block.

In the aforementioned aspect of the video decoding apparatus, the bit stream parsing unit creates an intensity compensation table which comprises the intensity compensation data and is created on a picture-by-picture basis.

In addition, the intensity compensation data may comprise a memory index of the motion compensation picture, frequency of the intensity compensation, and at least one intensity compensation coefficient required for creating a lookup table to perform the intensity compensation.

In addition, the intensity compensation unit may comprise a motion compensation reading unit which reads the motion compensation block from the memory; an intensity compensation unit which creates a lookup table with respect to the motion compensation block by receiving the intensity compensation data from the bit stream parsing unit and remaps the motion compensation block using the lookup table; and a motion compensation processing unit which performs the motion compensation using the remapped motion compensation block.

In addition, the motion compensation unit may comprise: a first intensity compensation unit which remaps the motion compensation block using a lookup table created using a first intensity compensation coefficient if the intensity compensation frequency equals one (1) or two (2); and a second intensity compensation unit which remaps the remapped motion compensation block using a lookup table created using a second intensity compensation coefficient if the intensity compensation frequency equals two (2).

In addition, the decoding unit may comprise: a reverse conversion unit which performs a reverse inversion process with respect to an inter picture output from the bit stream parsing unit; a motion vector estimation unit which finds a motion vector for the motion compensation blcok; and an addition unit which adds an output of the motion compensation unit and an output of the reverse conversion unit.

According to another aspect of the present invention, there is provided a video decoding apparatus comprising: a bit stream parsing unit which parses an input bit stream, extracts intensity compensation data of a picture to be decoded, and creates a lookup table with respect to a motion compensation picture that is referred to by the picture to be decoded for motion compensation; a decoding unit which decodes the picture to be decoded; and a memory which stores the decoded picture, wherein the decoding unit comprises a motion compensation unit which reads a motion compensation picture from the memory in block unit of a predetermined size, performs intensity compensation with respect to a motion compensation block of the motion compensation picture using the created lookup table, and performs the motion compensation with respect to the intensity-compensated motion compensation block.

According to still another aspect of the present invention, there is provided a video decoding method comprising: parsing an input bit stream, extracting intensity compensation data a picture to be decoded from the input bitstream and creating a lookup table using the intensity compensation data; performing intensity compensation with respect to a motion compensation block of a motion compensation picture that is referred to by the picture to be decoded for motion compensation, using the lookup table, in block unit of a predetermined size, and performing the motion compensation with respect to the intensity-compensated motion compensation block.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram of a video decoding apparatus according to an exemplary embodiment of the present invention;

FIG. 2 is a block diagram of a motion compensation unit according to an exemplary embodiment of the present invention;

FIG. 3 is a block diagram illustration an intensity compensation unit according to an exemplary embodiment of the present invention;

FIG. 4 is a view of an intensity compensation table according to an exemplary embodiment of the present invention;

FIG. 5 is a view of an intensity compensation implementation process on a field picture according to an exemplary embodiment of the present invention;

FIG. 6 is a flowchart illustrating a video decoding method according to an exemplary embodiment of the present invention; and

FIG. 7 is a flowchart illustrating an intensity compensation processing method according to an exemplary embodiment of the present invention.

### DETAILED DESCRIPTION OF THE EXEMPLARY EMBODIMENTS

Hereinafter, exemplary embodiments of the present invention will be described in detail with reference to the accompanying drawings.

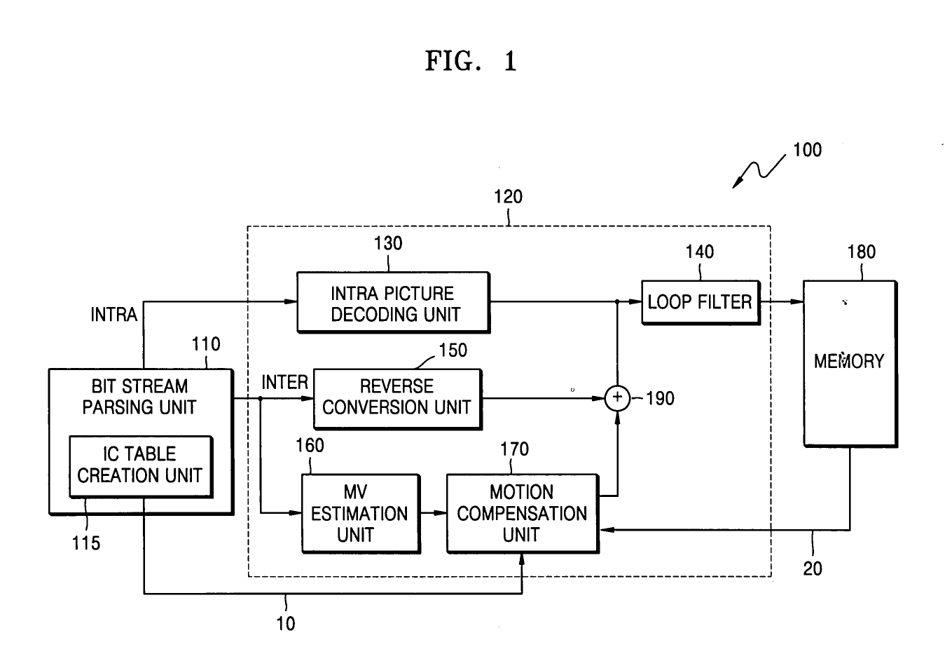

FIG. 1 is a block diagram of a video decoding apparatus according to an exemplary embodiment of the present invention. The video decoding apparatus 100 includes a bit stream parsing unit 110, a decoding unit 120, and a memory 180.

The bit stream parsing unit 110 parses an input bit stream. The decoding unit 120 decodes the parsed bitstream to form a picture. A reference picture, which has been read in block unit of a predetermined size, using intensity compensation data among the parsed data, is subject to an intensity compensation (IC), and then is decoded using the intensity-compensated block in the decoding unit 120. The memory 180 stores created pictures.

The bit stream parsing unit 110 parses an input bit stream and checks the MV mode. The MV mode, a syntax existing in a header of a P or B picture in the VC-1, may include IC mode data. If IC mode data is included in the MV mode, IC data is extracted. The IC data includes pointer data which indicates a memory index of a reference picture to be processed with IC, frequency of IC with respect to the reference picture to be processed with IC, and parameters of LUMASCALE and LUMASHIFT which are IC coefficients required for IC of the reference picture. The parameters of LUMASCALE and LUMASHIFT existing in the header of the P picture are set for each picture and are weight parameters required for configuring a lookup table according to the VC-1.

The bit stream parsing unit 110 includes an IC table creation unit 115 so as to create an IC table for a picture to be decoded using IC data which is extracted if the MV mode includes IC mode data, and transfers the created IC table to a motion compensation unit 170 in the decoding unit 120.

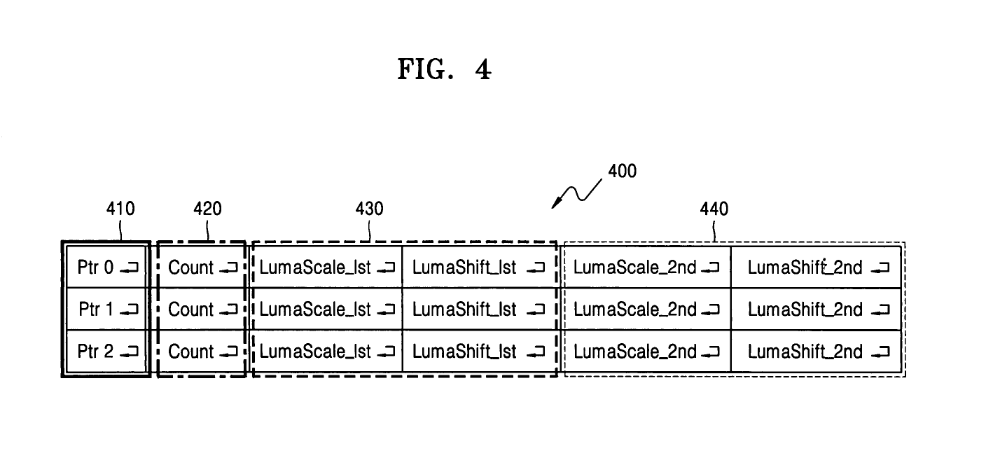

An IC table will be described with reference to FIG. 4. FIG. 4 is a view of an IC table according to an exemplary embodiment of the present invention.

An IC table 400 stores data required for performing IC with respect to each picture to be decoded. The IC table 400 is updated whenever starting picture decoding in a picture layer parsing process and is stored for a current picture and a picture to be decoded afterward. While performing IC, data of how many times IC has been performed so far with respect to each reference picture and IC data in a header of each picture which has been used for IC of the reference picture must be transferred. Accordingly, if a reference field in the VC-1 is processed with the IC process two times, the result of the first IC process is used as an input for the second IC process.

The IC data of the IC table 400 includes pointer data 410, remapping frequency 420, parameters 430 and 440 of LUMASCALE and LUMASHIFT required for configuring the lookup table. The pointer data 410 is a memory index of a picture to be remapped. The pointer data 410 includes top-bottom information. In the case of a field picture, a top field is referred when the pointer data 410 is an even number whereas a bottom field is referred when an odd number. In the case of a frame picture, the pointer data 410 is always an even number.

The remapping frequency 420 is the number of times of performing IC. The remapping frequency 420 is limited to maximum two times in the case of a field based picture. The parameter 430 of LumaScale_{—}1st and LumaShift_{—}1st represents IC coefficients required for configuring a lookup table for the first remapping, and the parameter 440 of LumaScale_{—}2nd and LumaShift_{—}2nd represents IC coefficients required for configuring a lookup table for the second remapping. Maximum three rows are included in the IC table 400, wherein the table corresponding to a forward reference picture has maximum two rows and the table corresponding to a backward reference picture has maximum one row.

Referring again to the video decoding apparatus 100 of FIG. 1, the decoding unit 120 includes an intra picture decoding unit 130, a loop filter 140, a reverse conversion unit 150, an MV estimation unit 160, a motion compensation unit 170, and an addition unit 190. The intra picture decoding unit 130 decodes an intra picture by performing AC/DC estimation process and reverse conversion process, that is, variable length decoding, inverse quantization, and inverse DCT with respect to the intra picture. Since the intra picture is decoded without estimation process, the intra picture is directly subject to the loop filter 140 and then is stored in the memory 180. The loop filter 140, which can be selectively used, reduces distortion generated due to quantization.

An inter picture is differentiated from the intra picture in inverse conversion and inverse quantization, so the inter picture is decoded by additionally being subject to the reverse conversion unit 150, the MV estimation unit 160, and the motion compensation unit 170. The reverse conversion unit 150 carries out decoding by performing inverse conversion with respect to the inter picture. The MV estimation unit 160 finds a motion vector, and the motion compensation unit 170 performs motion compensation. The addition unit 190 creates a restored picture by adding a reference block processed with the motion compensation and the inter picture processed with the inverse conversion.

The motion compensation unit 170 according to an exemplary embodiment of the present invention creates a lookup table by receiving IC table data from the IC table creation unit 115 as shown as an arrow 10. Next, as shown as an arrow 20, a reference picture is read from the memory 180 in block unit of a predetermined size, and the read reference block is remapped using the created lookup table. It is the IC process that the reference picture in block unit is remapped using the lookup table. The reference block processed with IC is subject to the motion compensation process and then is added with an output of the inversion conversion unit 150, and the motion compensation process is thereby complete. The picture which completed the motion compensation process is subject to the loop filter 140 and then is stored in the memory 180.

Although it has been described that the lookup table is created in the motion compensation unit 170, the lookup table may be created in the bit stream parsing unit 110, and the created lookup table may be transferred to the motion compensation unit 170.

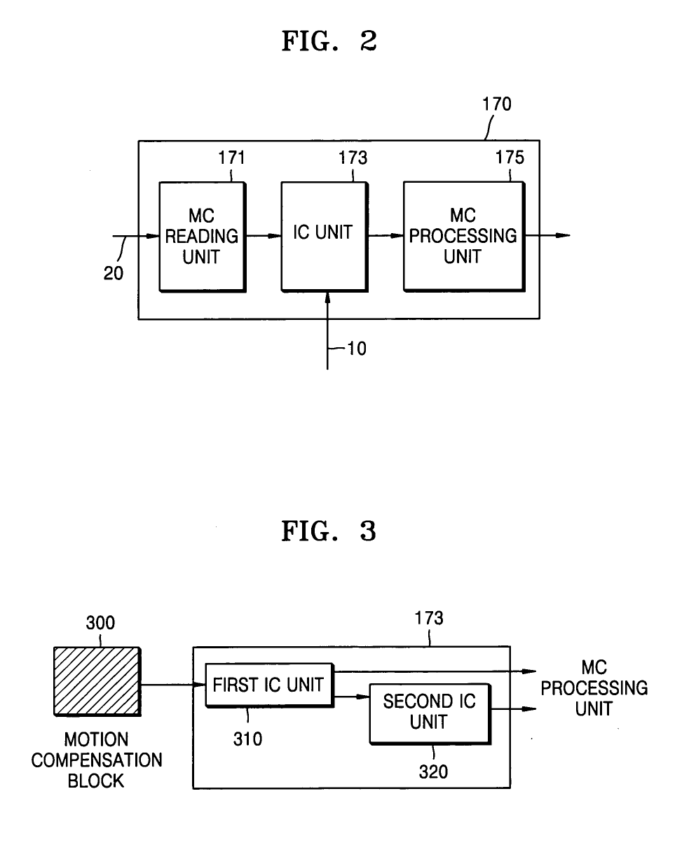

FIG. 2 is a block diagram of the motion compensation unit 170 according to an exemplary embodiment of the present invention. Referring to FIGS. 1 and 2, the motion compensation process of the present invention will be described in more detail.

The motion compensation unit 170 according to an exemplary embodiment of the present invention includes a motion compensation (MC) reading unit 171, an IC unit 173, and an MC processing unit 175.

The MC reading unit 171 reads an MC block, which is referred to by a current picture to be decoded so as to perform MC, from the memory 180 as shown as the arrow 20. The MC block is transferred to the IC unit 173 and then is subject to IC.

The IC unit 173 receives the IC table from the bit stream parsing unit 110 as shown as the arrow 10, creates the lookup table using the parameters of LUMASCALE and LUMASHIFT, the IC coefficients, and performs IC by remapping the MC block using the lookup table. Alternatively, if the bit stream parsing unit 110 creases the lookup table, the IC unit 173 performs the IC by receiving the lookup table.

The MC processing unit 175 serves to perform a filtering process required when the size of the currently decoded block and the size of the MC block are different, for example, the motion vector is a half-pel or a quarter-pel. If the motion vector is an integer-pel, additional filtering process is not performed.

Accordingly, a conventional IC process, wherein the whole reference picture data is read from the memory 180, the read picture is subject to IC, and then is stored in the memory 180 again, becomes unnecessary, because in the MC process according to the exemplary embodiment of the present invention, MC is performed after IC is performed in block unit. In addition, the MC unit 170 no longer has to continuously access the memory 180 in order to refer to the data processed with IC.

FIG. 3 is a block diagram illustration a structure of the IC unit 173 according to an exemplary embodiment of the present invention. Referring to FIGS. 2 and 3, the IC process of an exemplary embodiment of the present invention will be described in more detail.

An MC block 300 read by the MC reading unit 171 is input to the IC unit 173. If IC is performed only one time, a first IC unit 310 remaps the MC block 300 using the lookup table created by the use of first IC coefficients, and the remapped data is input to the MC processing unit 175, and thereby MC process is performed.

If IC must be performed two times with respect to the MC block 300 read by the MC reading unit 171, the first IC unit 310 remaps the MC block 300 using the lookup table created by the use of first IC coefficients, and a second IC unit 320 remaps the remapped block using the lookup table created by the use of second IC coefficients. As a result, the data which has been remapped two times is input to the MC processing unit 175 and thereby the MC process is performed.

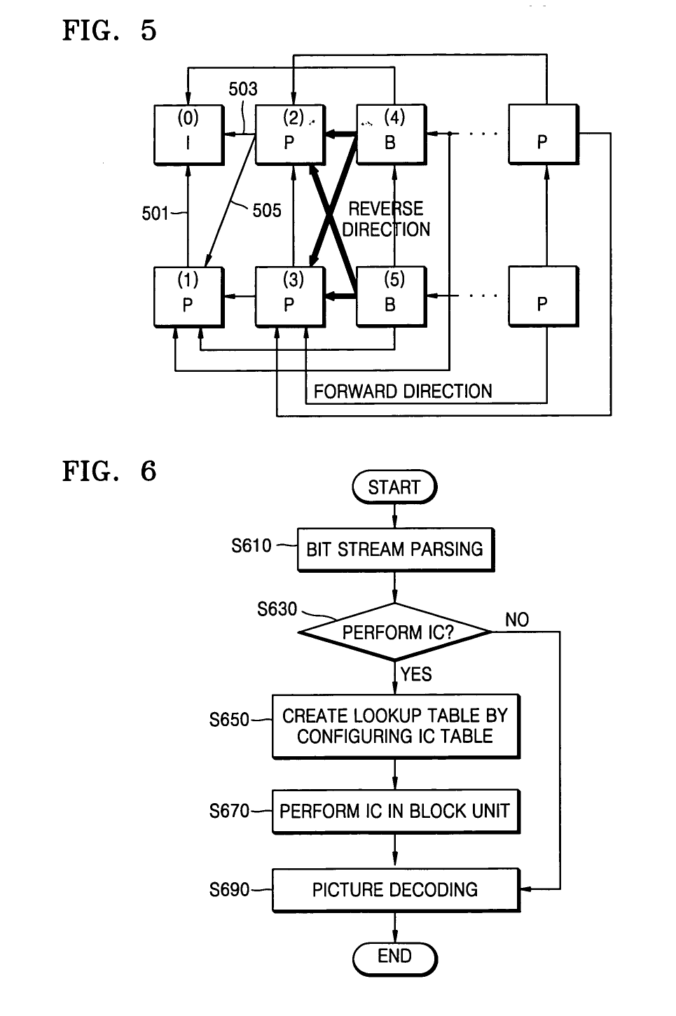

FIG. 5 is a view of an IC implementation process on a field picture according to an exemplary embodiment of the present invention.

The numbers 0, 1, 2, . . . on the field picture of FIG. 5 indicates a memory index of the field picture. The arrow indicates the reference picture that is referred to by the picture to be decoded. For example, a picture 1 takes a picture 0 as a reference picture as shown as an arrow 501, and a picture 2 takes the picture 0 and the picture 1 as reference pictures as shown as arrows 503 and 505.

The picture 1, that is a P field picture, refers to the picture 0 in block unit while decoding. If a bit stream with respect to the picture 1 has the IC mode data, the IC process is performed. At this time, among the IC data in the header of the picture 1, if the IC coefficient is marked as LumaScale_1st and LumaShift_1st, the block of the reference picture 0 uses a lookup table created by the use of the LumaScale_1st and LumaShift_1st and IC is performed.

An IC table which is created with respect to the picture 1 for the picture 1 and the picture that will refer to the picture 1 afterward is shown as Table 1.

TABLE 1

| ptr | Count | LumaScale_1st | LumaShift_1st | LumaScale_2nd | LumaShift_2nd |
|---|---|---|---|---|---|
| 0 | 1 | LumaScale_1st | LumaShift_1st | 0 | 0 |

Table 1, an IC table for the picture 1, shows that the memory index of the picture to be referred to is picture 0, IC is performed one time, and IC coefficients required for creating the lookup table are LumaScale_1st and LumaShift_1st.

The IC process with respect to the picture 2 will be described. The picture 2 refers to the picture 0 and the picture 1 in block unit during decoding. When the picture 2 refers to the picture 0, as shown in FIG. 5, if the picture 0 has been taken as a reference picture of the picture 1 during the IC process, in order to refer to the picture 0, the IC data in the header of the picture 1 which has referred to the picture 0 must be taken into account first. So, when the picture 2 refers to the picture 0, the IC process must be first performed using the IC data in the header of the picture 1, and the IC process must be secondly performed using the IC data in the header of the current picture 2. Accordingly, when IC is performed two times, the process of creating a lookup table using the IC data must be also performed two times.

When the picture 2 refers to the picture 1, the IC process is performed only one time using the IC data in the header of the current picture 2. The IC table for the picture 2 can be seen as Table 2. In Table 2, the parameters with respect to the brightness of the picture 0 and the picture 1 are marked as the LumaScale_1st and LumaShift_1st, but as described above, these parameters are set for each picture and may be different from each other, and this is applied in the table below.

TABLE 2

| ptr | Count | LumaScale_1st | LumaShift_1st | LumaScale_2nd | LumaShift_2nd |
|---|---|---|---|---|---|
| 0 | 2 | LumaScale_1st | LumaShift_1st | LumaScale_2nd | LumaShift_2nd |
| 1 | 1 | LumaScale_1st | LumaShift_1st | 0 | 0 |

The IC process with respect to the picture 3 will be described. The picture 3 refers to the picture 1 and the picture 2 in block unit during decoding. When the picture 3 refers to the picture 1, if the picture 1 has been taken as a reference picture of the picture 2 and IC has already been performed, the IC process must be first performed using the IC data in the header of the the picture 2, and the IC process must be secondly performed using the IC data in the header of the current picture 3.

When the picture 3 refers to the picture 2, the IC process is performed only one time using the IC data in the header of the current picture 3. The IC table for the picture 3 can be seen as Table 3.

TABLE 3

| ptr | Count | LumaScale_1st | LumaShift_1st | LumaScale_2nd | LumaShift_2nd |
|---|---|---|---|---|---|
| 1 | 2 | LumaScale_1st | LumaShift_1st | LumaScale_2nd | LumaShift_2nd |
| 2 | 1 | LumaScale_1st | LumaShift_1st | 0 | 0 |

The IC process with respect to the picture 4 will be described. The picture 4 is a B picture and does not have the IC data for an additional IC compensation. While decoding the picture 4, the picture 0 and the picture 1 are referred to in block unit in forward direction, whereas the picture 2 and the picture 3 are referred to in reverse direction.

As shown in FIG. 5, if the picture 0 is referred to by the picture 1 and the picture 2, so the picture 0 is referred to two times, in order for the picture 4 to refer to the picture 0, the IC process must be first performed using the IC data in the header of the picture 1, and then the IC process must be secondly performed using the IC data in the header of the picture 2. When the picture 4 refers to the picture 1, since the picture 1 is referred to by the picture 2 and picture 3, the IC process must be first performed using the IC data in the header of the picture 2, and the IC process must be secondly performed using the IC data in the header of the picture 3. When the picture 4 refers to the picture 2, since the picture 3 has referred to the picture 2, the IC process is performed using the IC data in the header of the picture 3. When the picture 4 refers to the picture 3, there is no IC data to be taken into account since the picture 4 does not have IC data. The IC table for the picture 4 can be seen as table 4.

TABLE 4

| ptr | Count | LumaScale_1st | LumaShift_1st | LumaScale_2nd | LumaShift_2nd |
|---|---|---|---|---|---|
| 0 | 2 | LumaScale_1st | LumaShift_1st | LumaScale_2nd | LumaShift_2nd |
| 1 | 2 | LumaScale_1st | LumaShift_1st | LumaScale_2nd | LumaShift_2nd |
| 2 | 1 | LumaScale_1st | LumaShift_1st | 0 | 0 |

The IC process with respect to the picture 5 will be described. During decoding, the picture 5 refers to the picture 4 and the picture 1 in block unit in forward direction, whereas refers to the picture 2 and the picture 3 in reverse direction.

As shown in FIG. 5, if the picture 1 is referred to by the picture 2 and picture 3, in order for the picture 5 to refer the picture 1, the IC process must be first performed using the IC data in the header of the picture 2, and then the IC process must be secondly performed using the IC data in the header of the picture 3. When the picture 5 refers the picture 4, since the picture 4 is not referred to by any pictures, there is no IC data taking the picture 4 as a pointer. If referred in reverse direction, when the picture 5 refers the picture 2, the picture 2 is referred by the picture 3 and the picture 4. So the IC process is performed using the IC data in the header of the picture 3. When the picture 5 refers the picture 3, the picture 3 is referred to by the picture 4 and the picture 5, and the picture 4 and the picture 5 do not have additional IC data. The IC table for the picture 5 can be seen as Table 5.

TABLE 5

| ptr | count | LumaScale_1st | LumaShift_1st | LumaScale_2nd | LumaShift_2nd |
|---|---|---|---|---|---|
| 1 | 2 | LumaScale_1st | LumaShift_1st | LumaScale_2nd | LumaShift_2nd |
| 2 | 1 | LumaScale_1st | LumaShift_1st | 0 | 0 |

FIG. 6 is a flowchart illustrating a video decoding method according to an exemplary embodiment of the present invention.

A received bit stream is parsed (operation S610), and whether or not IC mode data exists and thereby IC must be performed is determined by checking the MV mode (operation S630). If IC mode data does not exist, normal picture decoding is performed without the IC process (operation S690).

If IC mode data exists, an IC table is configured using the extracted IC data, and a lookup table is created using IC coefficients among the data in the IC table (operation S650). The IC process is performed in block unit using the lookup table (operation S670). A picture is decoded by performing the MC process (operation S690).

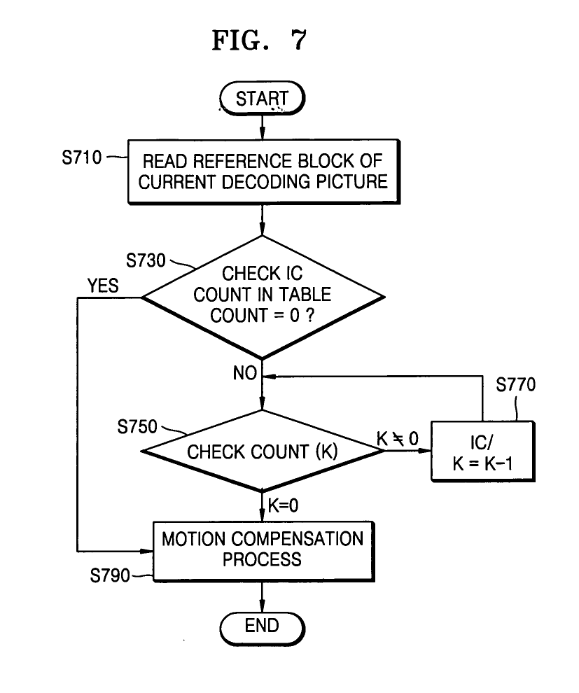

FIG. 7 is a flowchart illustrating an IC processing method according to an exemplary embodiment of the present invention.

A reference picture of a current picture to be decoded is read in block unit (operation S710). Whether or not the reference picture having the reference block is included in the pointer data, that is, the memory index of the reference picture having the reference block is included in the IC table is checked (operation S730). If the reference block is not included in the pointer data, that is, a count k, or frequency of the IC with respect to the reference block, equals 0, MC is performed without the IC process (operation S790).

If the count k with respect to the reference block is not 0, it means that IC data exists, and IC must be performed. Therefore, the count k is checked (operation S750), and if the count k is not 0, IC is performed by remapping the reference block using a lookup table created by the use of the corresponding IC data while decreasing the count k one by one (operation S770). If the count k equals 2, IC is performed in an order that IC has been performed with respect to the reference picture. For example, in the case of the pointer 1 of Table 5, IC is performed by remapping the reference block using the lookup table created by the use of the LumaScale_{—}1st and LumaShift_{—}1 st, and IC is secondly performed using the lookup table created by the use of the LumaScale_{—}2nd and LumaShift_{—}2nd. This process is repeated until the count k becomes 0 with respect to all pointers. By checking the count k, if the count k equals 0, MC process is performed (operation S790).

Accordingly, in a video decoding method and apparatus of an exemplary embodiment of the present invention, when VC-1 is implemented as hardware, a memory bandwidth can be reduced by performing reading and storing processes from/to a memory in block unit instead of picture unit, and pipelining can be readily performed in macro-block unit.

In addition, in the video decoding method and apparatus of an exemplary embodiment of the present invention, a memory is not additionally accessed for IC by a method wherein IC is performed in a motion compensation process, so the memory is less accessed, resulting in effective IC.

The exemplary embodiments of the present invention can be written as computer readable code and can be implemented in general-use digital computers that execute the programs using a computer readable recording medium. Examples of the computer readable recording medium include ROM, RAM, CD-ROMs, magnetic tapes, floppy disks, optical recording media, and storage media such as carrier waves (i.e., transmission through the Internet). Further, the computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A video decoding apparatus comprising:
a bit stream parsing unit which parses an input bit stream, and extracts intensity compensation data of a picture to be decoded;
a decoding unit which decodes the picture to be decoded; and
a memory which stores the decoded picture,
wherein the decoding unit comprises a motion compensation unit which reads a motion compensation picture, that is referred to by the picture to be decoded for motion compensation, from the memory in block unit of a predetermined size, performs intensity compensation with respect to a motion compensation block of the motion compensation picture using the intensity compensation data, and performs the motion compensation with respect to the intensity-compensated motion compensation block.

2. The video decoding apparatus according to claim 1, wherein the bit stream parsing unit creates an intensity compensation table which comprises the intensity compensation data and is created on a picture-by-picture basis.

3. The video decoding apparatus according to claim 1, wherein the intensity compensation data comprises a memory index of the motion compensation picture, frequency of the intensity compensation, and at least one intensity compensation coefficient required for creating a lookup table to perform the intensity compensation.

4. The video decoding apparatus according to claim 1, wherein the motion compensation unit comprises:
a motion compensation reading unit which reads the motion compensation block from the memory;
an intensity compensation unit which creates a lookup table with respect to the motion compensation block by receiving the intensity compensation data from the bit stream parsing unit and remaps the motion compensation block using the lookup table; and
a motion compensation processing unit which performs the motion compensation using the remapped motion compensation block.

5. The video decoding apparatus according to claim 4, wherein the intensity motion compensation unit comprises:
a first intensity compensation unit which remaps the motion compensation block using a lookup table created using a first intensity compensation coefficient if the intensity compensation frequency equals one (1) or two (2); and
a second intensity compensation unit which remaps the remapped motion compensation block using a lookup table created using a second intensity compensation coefficient if the intensity compensation frequency equals two (2).

6. The video decoding apparatus according to claim 1, wherein the decoding unit comprises:
a reverse conversion unit which performs a reverse inversion process with respect to an inter picture output from the bit stream parsing unit;
a motion vector estimation unit which finds a motion vector; and
an addition unit which adds an output of the motion compensation unit and an output of the reverse conversion unit.

7. A video decoding apparatus comprising:
a bit stream parsing unit which parses an input bit stream, extracts intensity compensation data of a picture to be decoded, and creates a lookup table with respect to a motion compensation picture that is referred to by the picture to be decoded for motion compensation;
a decoding unit which decodes the picture to be decoded; and
a memory which stores the decoded picture,
wherein the decoding unit comprises a motion compensation unit which reads a motion compensation picture from the memory in block unit of a predetermined size, performs intensity compensation with respect to a motion compensation block of the motion compensation picture using the created lookup table, and performs the motion compensation with respect to the intensity-compensated motion compensation block.

8. The video decoding apparatus according to claim 7, wherein the bit stream parsing unit creates an intensity compensation table which comprises the intensity compensation data and is created on a picture-by-picture basis.

9. The video decoding apparatus according to claim 7, wherein the intensity compensation data comprises a memory index of the motion compensation picture, frequency of the intensity compensation, and at least one intensity compensation coefficient required for creating a lookup table to perform the intensity compensation.

10. The video decoding apparatus according to claim 7, wherein the motion compensation unit comprises:
a motion compensation reading unit which reads the motion compensation block from the memory;
an intensity compensation unit which receives the lookup table from the bit stream parsing unit and remaps the motion compensation block using the lookup table; and
a motion compensation processing unit which performs the motion compensation using the remapped motion compensation block.

11. The video decoding apparatus according to claim 10, wherein the intensity compensation unit comprises:
a first intensity compensation unit which remaps the motion compensation block using a lookup table created using a first intensity compensation coefficient if the intensity compensation frequency equals one (1) or two (2); and
a second intensity compensation unit which remaps the remapped motion compensation block using a lookup table created using a second intensity compensation coefficient if the intensity compensation frequency equals two (2).

12. The video decoding apparatus according to claim 7, wherein the decoding unit comprises:
a reverse conversion unit which performs a reverse inversion process with respect to an inter picture output from the bit stream parsing unit;
a motion vector estimation unit which finds a motion vector; and
an addition unit which adds an output of the motion compensation unit and an output of the reverse conversion unit.

13. A video decoding method comprising:
parsing an input bit stream, extracting intensity compensation data of a picture to be decoded from the input bit stream and creating a lookup table using the intensity compensation data;
performing intensity compensation with respect to a motion compensation block of a motion compensation picture, that is referred to by the picture to be decoded for motion compensation, using the lookup table, in block unit of a predetermined size, and
performing the motion compensation with respect to the intensity-compensated motion compensation block.

14. The video decoding method according to claim 13, further comprising creating an intensity compensation table which comprises the intensity compensation data and is created on a picture-by-picture basis.

15. The video decoding method according to claim 13, wherein the intensity compensation data comprises a memory index of the motion compensation picture, frequency of the intensity compensation, and the at least one intensity compensation coefficient required for creating the lookup table to perform the intensity compensation.

16. The video decoding method according to claim 13, wherein the performing of the intensity compensation comprises:
reading the motion compensation block; and
remapping the read motion compensation block using the lookup table.

17. The video decoding method according to claim 16, wherein the remapping of the read motion compensation block comprises: remapping the read motion compensation block using a first lookup table created using a first intensity compensation coefficient if the intensity compensation frequency equals one (1) or two (2); and
remapping the read remapped motion compensation block using a second lookup table created using a second intensity compensation coefficient if the intensity compensation frequency equals two (2).

18. The video decoding method according to claim 13, further comprising storing a picture which is created after the performing of the motion compensation.

19. A computer-readable recording medium having embodied thereon a computer program for performing the method according to claim 13.

20. A computer-readable recording medium having embodied thereon a computer program for performing the method according to claim 14.

21. A computer-readable recording medium having embodied thereon a computer program for performing the method according to claim 15.

22. A computer-readable recording medium having embodied thereon a computer program for performing the method according to claim 16.

23. A computer-readable recording medium having embodied thereon a computer program for performing the method according to claim 17.

24. A computer-readable recording medium having embodied thereon a computer program for performing the method according to claim 18.
